(19) United States
(12) Patent Application Publication
(10) Pub. No.: US 2005/0285759 A1
(43) Pub. Date: Dec. 29, 2005

(54) Communication device and method for controlling the same

(75) Inventor: Naoki Sugawara, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/135,157

(22) Filed: May 23, 2005

(30) Foreign Application Priority Data
Jun. 11, 2004 (JP) 2004-174197

(51) Int. Cl. G08B 23/00

(52) U.S. Cl. 340/984

(57) ABSTRACT

A communication device includes a ship-to country-group setting unit for setting one from a plurality of ship-to country-groups for the communication device, wherein ship-to countries are grouped into ship-to country-groups, a ship-to country-group storing unit for storing the set ship-to country-group, a country-parameter-value selecting unit by which a user selects one from a plurality of ship-to countries in the corresponding ship-to country-group set by the ship-to country-group setting unit as a value of a ship-to country parameter, and a country-parameter-value storing unit for storing the selected ship-to country, wherein the selectable ship-to countries are limited to ship-to countries in the corresponding ship-to country-group set by the ship-to country-group setting unit.

### BACKGROUND OF THE INVENTION

1. Field of the Invention

The present invention relates to a communication device having a control function. The communication device stores and reads programs and parameters in and from a common ROM. These programs and parameters correspond to different standards and specifications for individual ship-to locations.

2. Description of the Related Art

When ship-to location data is set in known communication devices, this data is set at factory shipment.

A known communication device is disclosed in Japanese Patent Laid-Open No. 10-75322. This communication device is a facsimile device including substitution circuits formed on a network control unit (NCU) board, relays, and analog switches. These relays and analog switches change the substitution circuits. The facsimile device also includes a country-parameter table for storing communication control and NCU parameters for individual countries and a battery-backed-up country-setting area for storing data representing individual countries or these parameters. When power for the facsimile device is turned on, one of the substitution circuits is selected in compliance with the telephone communication standard of a corresponding country, and the communication control parameters are set to perform communication control of the facsimile device. The substitution circuit is selected based on entered data representing the corresponding country (in this case, a country code stipulated by ISO) or data stored in the country-setting area when no country code is designated.

Another communication device in which parameters are set for individual ship-to countries is disclosed in Japanese Patent Laid-Open No. 11-275247.

However, in these known communication devices, ship-to location data cannot be changed at places other than factories. Thus, these communication devices cannot be diverted, on sites in sales regions, for other ship-to locations.

Moreover, in the known communication devices, manufacturing costs increase due to an additional step of setting ship-to location data.

A method for avoiding an increase in the manufacturing costs is disclosed. In this method, ship-to location data is not set in factories, and users set the ship-to location data when the users use the devices for the first time after the devices are shipped from the factories.

In this method, when hardware is common for all ship-to locations, no problem occurs. However, the users can select any ship-to location. Thus, when the hardware is changed depending on ship-to locations, the users may set ship-to locations that the hardware does not support, and the devices may not function normally.

### SUMMARY OF THE INVENTION

The present invention provides a solution to these problems.

A communication device according to the present invention includes a ship-to country-group setting unit configured to set one from a plurality of ship-to country-groups for the communication device, wherein ship-to countries are grouped into ship-to country-groups, a ship-to country-group storing unit configured to store the set ship-to country-group, a country-parameter-value selecting unit by which a user selects one from a plurality of ship-to countries in the corresponding ship-to country-group set by the ship-to country-group setting unit as a value of a ship-to country parameter, and a country-parameter-value storing unit configured to store the selected ship-to country, wherein the selectable ship-to countries are limited to ship-to countries in the corresponding ship-to country-group set by the ship-to country-group setting unit. Thus, the user is prevented from setting a ship-to country that hardware of the communication device does not support, thereby assuring a normal operation of the communication device. Moreover, the communication device can be diverted for other ship-to locations.

Further features and advantages of the present invention will become apparent from the following description of exemplary embodiments with reference to the attached drawings.

### BRIEF DESCRIPTION OF THE DRAWINGS

FIG. 1 is a block diagram illustrating a communication device according to a first embodiment of the present invention.

FIG. 2 illustrates a typical ship-to country-group table according to the first embodiment.

FIG. 3 is a flowchart illustrating the process according to the first embodiment in which a user sets a ship-to country parameter upon using the communication device for the first time.

### DESCRIPTION OF THE EMBODIMENTS

Embodiments according to the present invention are described next.

### First Embodiment

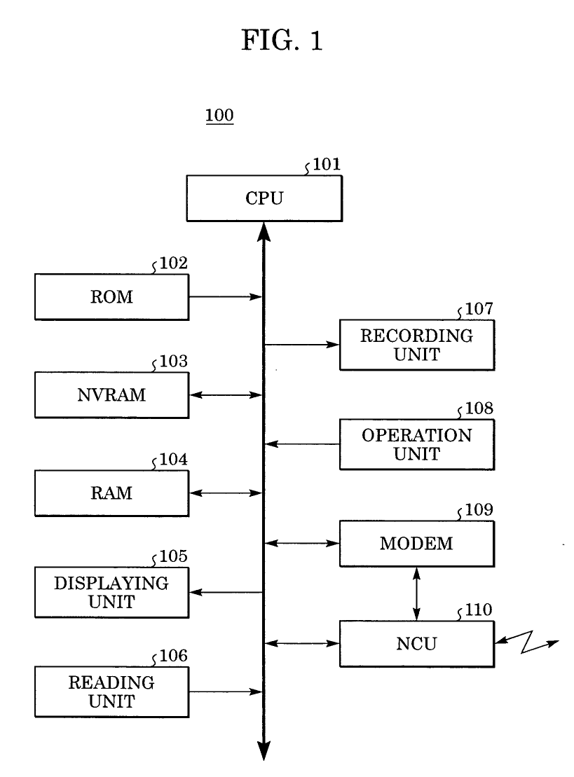

FIG. 1 is a block diagram illustrating a communication device 100 according to a first embodiment of the present invention.

The communication device 100 includes a country-parameter-value selecting unit by which a user selects one from a plurality of ship-to countries as a value of a ship-to country parameter and a country-parameter-value storing unit for storing the selected ship-to country in a memory. Specifically, the communication device 100 includes a CPU 101, a ROM 102, a nonvolatile RAM (NVRAM) 103, a RAM 104, a displaying unit 105, a reading unit 106, a recording unit 107, an operation unit 108, a MODEM 109, and a network control unit (NCU) 110.

The CPU 101 controls the communication device 100. The ROM 102 stores a control program of the communication device 100 and parameters of individual ship-to locations.

The NVRAM 103 permanently stores various types of setting data and operation-mode parameters. The RAM 104 stores image data and is used as a work memory required in the operation.

The displaying unit 105 displays a state of the communication device 100 and other information. The reading unit 106 reads a document in processes such as data transmission and copying. The recording unit 107 records a received image, an image read in the copying process, and other data.

The operation unit 108 includes a plurality of keys and is used for setting various types of parameters and submitting operation commands. The MODEM 109 encodes and decodes the received image and the read image in the reading unit 106. The NCU 110 controls networks for transmitting data and pulse signals. Several types of NCUs having different circuit structures are used as the NCU 110 so as to comply with standards in individual ship-to countries.

The operation unit 108, the CPU 101, and the ROM 102 constitute a typical ship-to country-group setting unit. Ship-to countries of communication devices are classified into a plurality of ship-to country-groups, and one of the ship-to country-groups is set for each communication device at factory shipment using this ship-to country-group setting unit.

The operation unit 108, the CPU 101, and the ROM 102 also constitute a typical selection-controlling unit. When the user selects one from the plurality of ship-to countries using the country-parameter-value selecting unit, this selection-controlling unit limits selectable ship-to countries to those in the corresponding ship-to country-group set by the ship-to country-group setting unit.

The process of setting the ship-to country-group at factory shipment according to the first embodiment is described next.

A ship-to country-group setting mode is selected by manipulating the keys (not shown) in the operation unit 108.

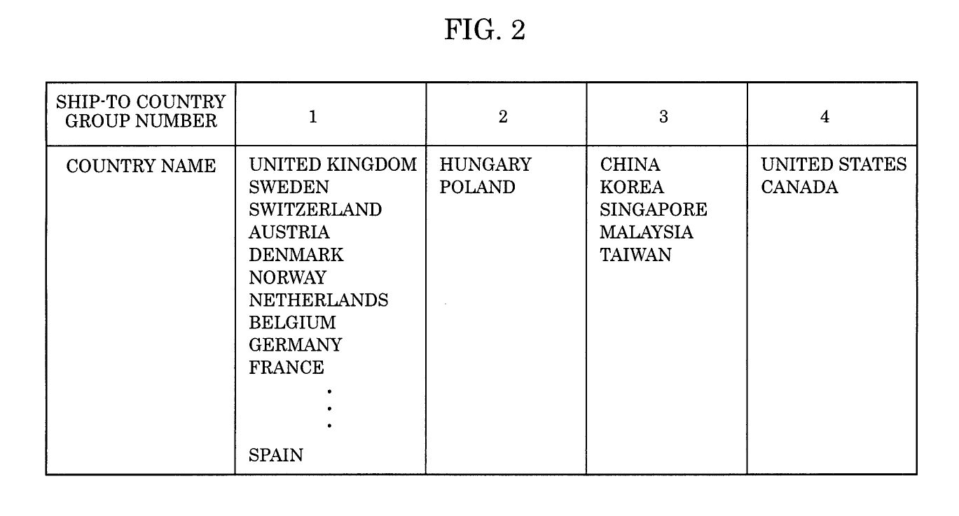

FIG. 2 illustrates a typical ship-to country-group table according to the first embodiment.

A ship-to country-group is selected from a plurality of ship-to country-groups shown in FIG. 2, and this group is stored in the NVRAM 103.

The process according to the first embodiment in which the user sets the ship-to country parameter upon using the communication device 100 for the first time is described next.

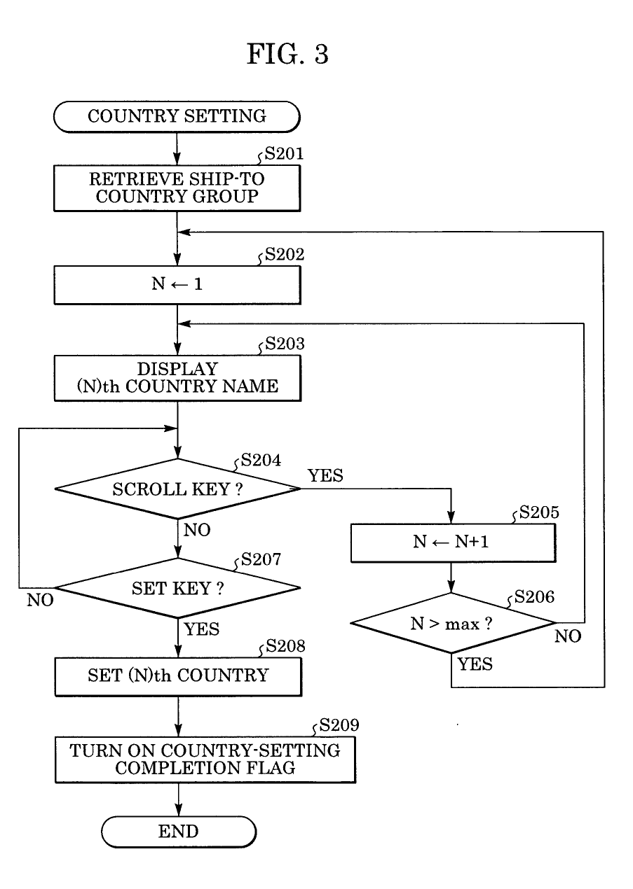

FIG. 3 is a flowchart illustrating this process.

When the user turns on power for the communication device 100, the communication device 100 starts up. At this time, a country-setting completion flag is read from the NVRAM 103. When the country-setting completion flag is not on, a ship-to country parameter is not set for the communication device 100, and the process enters a country-setting mode.

In step S201 in the country-setting mode, a ship-to country-group set at factory shipment is read. Then, in step S202, a parameter N is set to “1” to display a first country name in a corresponding ship-to country-group in the ship-to country-group table in the ROM 102, and in step S203, the (N)th country name is displayed on the displaying unit 105. For example, when the ship-to country-group is set to “1”, “United Kingdom” is displayed on the displaying unit 105.

Then, in step S204, when the user pushes any key, it is determined whether the user pushes a scroll key (not shown) in the operation unit 108. When the user pushes the scroll key, the process proceeds to step S205 where “1” is added to the parameter N to display the next country name. Then, in step S206, when it is determined that the parameter N exceeds the number of countries in the ship-to country-group, the process goes back to step S202. Otherwise, the process goes back to step S203.

On the other hand, in step S204, when it is determined that the user does not push the scroll key, the process proceeds to step S207. In step S207, when it is determined that the user does not push a set key (not shown) in the operation unit 108, the process goes back to step S204 and waits till the user pushes any key. When the user pushes the set key, the process proceeds to step S208 where the ship-to country parameter for the communication device 100 is set to the (N)th country in the ship-to country-group, and this ship-to country parameter and other parameters are stored in the NVRAM 103. Then, in step S209, the country-setting completion flag is turned on, and the process completes.

In the first embodiment, the communication device includes the country-parameter-value selecting unit by which the user selects one from a plurality of ship-to countries as a value of the ship-to country parameter and the country-parameter-value storing unit for storing the selected ship-to country in the memory. The communication device also includes the ship-to country-group setting unit. The ship-to countries are classified into the plurality of ship-to country-groups, and one of the ship-to country-groups is set for each communication device at factory shipment using this ship-to country-group setting unit. Moreover, when the user selects one from the ship-to countries using the country-parameter-value selecting unit, selectable ship-to countries are limited to those in the corresponding ship-to country-group set by the ship-to country-group setting unit. Thus, the user is prevented from setting a ship-to country that the hardware of the communication device does not support, thereby assuring a normal operation of the communication device. Moreover, the communication device can be diverted for other ship-to locations.

### Second Embodiment

According to the second embodiment, ship-to country-groups (shown in FIG. 2) classified in the first embodiment correspond to types of NCUs (types of hardware) included in individual communication devices. One of these ship-to country-groups corresponding to the type of NCU in each communication device is set at factory shipment. This setting of the ship-to country-group may be performed by automatically detecting the type of NCU.

In this embodiment, the user can select a ship-to country only from a ship-to country-group corresponding to the hardware of the communication device. Thus, the user is prevented from setting a ship-to country that the hardware does not support, thereby assuring a normal operation of the communication device. Moreover, the communication device can be diverted for other ship-to locations when the hardware is changed.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-174197 filed Jun. 11, 2004, which is hereby incorporated by reference herein.

1. A communication device comprising:
a ship-to country-group setting unit configured to set one from a plurality of ship-to country-groups for the communication device, wherein ship-to countries are grouped into the ship-to country-groups;
a ship-to country-group storing unit configured to store the set ship-to country-group;
a country-parameter-value selecting unit by which a user selects one from a plurality of ship-to countries in the corresponding ship-to country-group set by the ship-to country-group setting unit as a value of a ship-to country parameter; and
a country-parameter-value storing unit configured to store the selected ship-to country;
wherein the selectable ship-to countries are limited to ship-to countries in the corresponding ship-to country-group set by the ship-to country-group setting unit.

2. The communication device according to claim 1, wherein the ship-to country-groups correspond to types of hardware of the communication devices.

3. A method for controlling a communication device comprising:
setting one from a plurality of ship-to country-groups for the communication device, wherein ship-to countries are grouped into the ship-to country-groups;
storing the set ship-to country-group;
selecting one from a plurality of ship-to countries in the corresponding set ship-to country-group as a value of a ship-to country parameter; and
storing the selected ship-to country;
wherein the selectable ship-to countries are limited to ship-to countries in the corresponding set ship-to country-group.

4. The method according to claim 3, wherein the ship-to country-groups correspond to types of hardware of the communication devices.

5. Computer-executable process steps for causing a computer to execute the method of claim 3.

6. Computer-readable storage medium for storing the computer-executable process steps of claim 5.
